(19) United States
(12) Patent Application Publication
(10) Pub. No.: US 2010/0091320 A1
(43) Pub. Date: Apr. 15, 2010

(54) Front Panel Display Recordation

(76) Inventor: Lena Sojian, Fountain Valley, CA (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(21) Appl. No.: 12/250,794

(22) Filed: Oct. 14, 2008

(51) Int. Cl. G06F 3/12

(52) U.S. Cl. 358/1.15

(57) ABSTRACT

A system and method are provided for printing a screenshot displayed on a multifunctional peripheral (MFP) front panel. At an MFP front panel display, the method presents a screenshot, and an MFP processing unit stores the screenshot in a tangible memory medium. In response to recording a print screen command at a front panel user interface (UI), the MFP processing unit extracts the screenshot from memory and converts the extracted screenshot into a cyan, magenta, yellow, and key (black) (CMYK) printable format recognized by a print engine. Then, an MFP print engine prints a screenshot hardcopy.

### BACKGROUND OF THE INVENTION

1. Field of the Invention

This invention generally relates to the printing of electronic documents and, more particularly, to a system and method for recording the front panel display of a printing device.

2. Description of the Related Art

A multifunctional peripheral (MFP) is a device capable of performing multiple operations, such as the printing of electronic documents, scanning, faxing, copying, saving, and transceiving electronic files. An MFP also provides a front panel display or an liquid crystal display (LCD) screen User Interface (UI) that provides an interactive visual display for controlling and selecting the features of the MFP. MFP devices are now equipped with large LCD screens that can provide large amounts of information, much like a computer screen. Conventional MFP devices do not provide a way to automatically printout a screenshot of the front panel screen. This creates several problems for the user. A “screenshot” is the image shown on the display of a monitor, CRT, or LCD. As used herein, screenshot also refers to the digital information needed to create such as image.

For example, if the user wishes to obtain a hardcopy of an error messages displayed on the MFP front panel, the user must manually write the information onto paper. Manually recording information is error-prone, and more often than not, results in incorrect information being recorded. This not only introduces mistakes, but creates a document that may not be very informative or legible when referenced at a later time.

Another problem relates to the recording of pictures and images displayed on the MFP front panel. For example, if the MFP displays a diagram showing the location of a paper jam, the user must manually draw the diagram to show others. Manually drawing diagrams, images, and figures displayed on the MFP front panel is not only tedious, but perfect accuracy is nearly impossible, so the user tends to ignore or bypass valuable information that could potentially impact the user's productivity.

Another problem relates to the translation of messages on an MFP that is configured in a language not understood by the user, e.g., if the MFP is configured in a foreign language, the user may wish to decipher the message on the front panel. Such a case requires a person who is familiar with the language be present at the MFP to translate, which at times may be impossible. It would be advantageous a user could printout the screenshot and present the printout to one who can translate remotely.

Yet another problem relates to the documentation of the MFP screens in a user manual or training document. If the user wishes to document the exact screenshot of the MFP, the user is required to create the screenshot using separate graphics design tools on the users PC. It is often times difficult and time-consuming to re-produce the screenshots exactly as they are displayed on the MFP. Additionally, since screenshots differ among the various product families and firmware versions, oftentimes, users need to recreate screens that have already been generated. It would be advantageous if a user could automatically print all, or a subset of the screenshots on an MFP.

To solve some of the above-mentioned problems, a user might take a snapshot of the screen using a camera or other image recording device external to the MFP. The images are then loaded from the recording device onto the user's PC, and transferred for analysis. This solution is not always possible, since users often times do not have immediate access to a camera. This may potentially keep the MFP out of commission until the user is able to locate a camera, or gives up trying, either of which is not desirable.

Microsoft provides a PrintScreen function for the Windows Operating System, which allows the user to print the graphics screen images displayed by a monitor. The PrintScreen function is implemented by first selecting the PrtScr key on a keyboard, which triggers the Operating System to automatically store the screen image displayed on the monitor, to the Windows clipboard. The user then selects a separate graphics application, pastes the image from the clipboard to the application, and selects to print the image to a specific printer.

It would be advantageous if a function similar to PrintScreen could be developed for use with an MFP and other systems that operate without the use of an operating system.

### SUMMARY OF THE INVENTION

Disclosed herein is a method that permits an MFP to automatically printout the screenshot displayed on the MFP front panel screen. For information to be displayed on the front panel display, the MFP generates a bitmap image that is sent to the video RAM buffer. This image is generated internally by the MFP, and is generated for every page that is displayed on the front panel. The method extracts the bitmap data sent to the video RAM buffer, and converts the bitmap data into a printable format recognized by the print engine. Once the bitmap data is converted to a printable format, it is sent to the print engine and the screenshot is output onto hard copy. This results in a hardcopy printout of the exact screenshot that is displayed on the MFP front panel. Thus, any screenshot displayed on an MFP front panel can be printed without image and graphics processing. Multiple screenshots can be printed in batch mode. Further, the screenshots may be printed using print settings selected using an MFP user interface, such as the number of copies, duplex, scaling, etc.

Accordingly, a method is provided for printing a screenshot displayed on an MFP front panel. At an MFP front panel display, the method presents a screenshot, and an MFP processing unit stores the screenshot in a tangible memory medium. In response to recording a print screen command at a front panel user interface (UI), the MFP processing unit extracts the screenshot from memory and converts the extracted screenshot into a printable format recognized by a print engine. Then, the MFP print engine prints a screenshot hardcopy. In one aspect, the screenshot is presented as RGB data and converted into a cyan, magenta, yellow, and key (black) or CMYK format.

Also provided is a method for saving a screenshot displayed on an MFP front panel. The method presents a screenshot on an MFP front panel display, and an MFP processing unit stores the screenshot in a tangible memory medium. In response to recording a screen save command at a front panel UI, the MFP processing unit extracts the screenshot from memory and converts the extracted screenshot into a compressed file format. Then, the compressed file is saved in an MFP tangible memory medium. In one aspect, the compressed file is sent as an email attachment.

Additional details of the above-described methods, as well as systems for saving and printing MFP display images are presented below.

### BRIEF DESCRIPTION OF THE DRAWINGS

FIG. 1 is a schematic block diagram of a system for printing a screenshot displayed on a multifunctional peripheral (MFP) front panel.

FIG. 2 is a schematic block diagram of an MFP with a system for saving a screenshot displayed on an MFP front panel.

FIG. 3 is a schematic diagram depicting an exemplary process performed by the screen page processor of FIGS. 1 and 2.

FIG. 4 is a diagram depicting a variation of the system of FIG. 1.

FIGS. 5A and 5B is a flowchart combining aspects of the methods depicted in FIGS. 7 and 8.

FIG. 6 is a schematic diagram depicting a variation of the system of FIG. 2.

FIG. 7 is a flowchart illustrating a method for printing a screenshot displayed on an MFP front panel.

FIG. 8 is a flowchart illustrating a method for saving a screenshot displayed on an MFP front panel.

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “processor”, “processing device”, “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of components, modules, and the like. It is to be understood and appreciated that the various systems may include additional components, modules, etc. and/or may not include all of the components, modules etc. discussed in connection with the figures. A combination of these approaches may also be used.

The various illustrative logical blocks, modules, and circuits that have been described may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the node, or elsewhere. In the alternative, the processor and the storage medium may reside as discrete components in the node, or elsewhere in an access network.

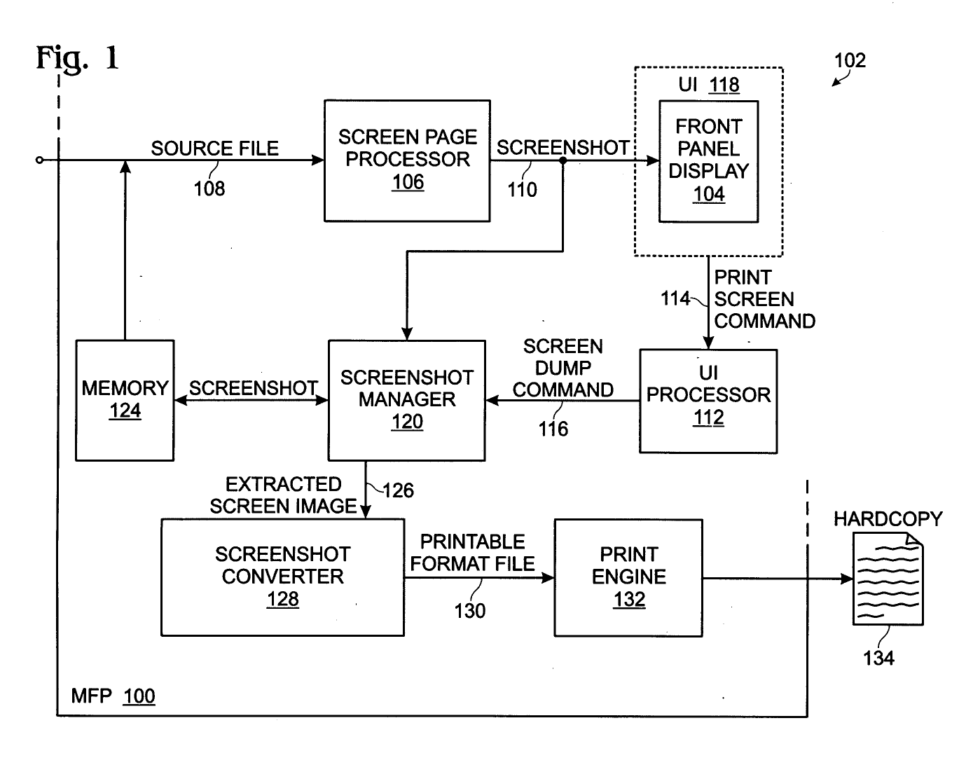

FIG. 1 is a schematic block diagram of a system for printing a screenshot displayed on a multifunctional peripheral (MFP) front panel. The MFP 100 comprises a system 102 for printing the screenshot. The system 102 comprises an MFP front panel display 104 for presenting a screenshot. A screen page processor 106 has an input on line 108 to accept a source file and an output on line 110 to present a screenshot for display on an MFP front panel display 104. A user interface (UI) processor 112 has an input on line 114 to accept a print screen command and an output on line 116 to supply a Screen Dump command. For example, the print screen command may be received from a front panel UI 118, such as a keyboard, keypad, or mouse (not shown) in combination with display 104. Alternately, the print screen command may originate from a network connected client device computer (not shown) or server (not shown).

A screenshot manager 120 has an interface on line 110 to accept the screenshot from the screen page processor 106 for storage in a tangible memory medium 124, and an output on line 126 to supply the screenshot extracted from the memory 124 in response to receiving the screen dump command on line 116. A screenshot converter 128 has an input on line 126 to accept the screenshot extracted from memory 124, and an output on line 130 to supply the screenshot converted into a file in a cyan, magenta, yellow, and key (black) (CMYK) printable format. An MFP print engine 132 has an input on line 130 to accept the CMYK printable format file and an output to supply a screenshot hardcopy 134. The screenshot converter, screen page processor, UI processor, and screenshot manager may be enabled as logical blocks, modules, and circuits, as described above.

In one aspect, the screen page processor 106 supplies the screenshot on line 110 as RGB data. However, since uncompressed data takes up more room than compressed data, in one aspect the displayed image is compressed before storing, and then uncompressed to print. In another aspect, the screen page processor 106 receives the source file on line 108 in a screen description language (e.g., HTML). Then, the screen page processor 106 processes the screen description commands within the source file and generates screenshot RBG data from the source file. For example, the screen page processor may be an HTML browser that processes HTML command. Alternately, the source file may contain proprietary screen description commands recognized by a proprietary browser on the MFP.

For example, the screen page processor 106 supplies the screenshot as RGB data on line 110. The screenshot manager 120 stores the screenshot as RGB data, and the screenshot converter 128 converts the extracted screenshot into CYMK printable format. In a different aspect, the screenshot converter 128 may include some data storage capabilities (not shown), and it performs rendering, color conversion, and half-toning processing of the RGB data as part of the conversion process.

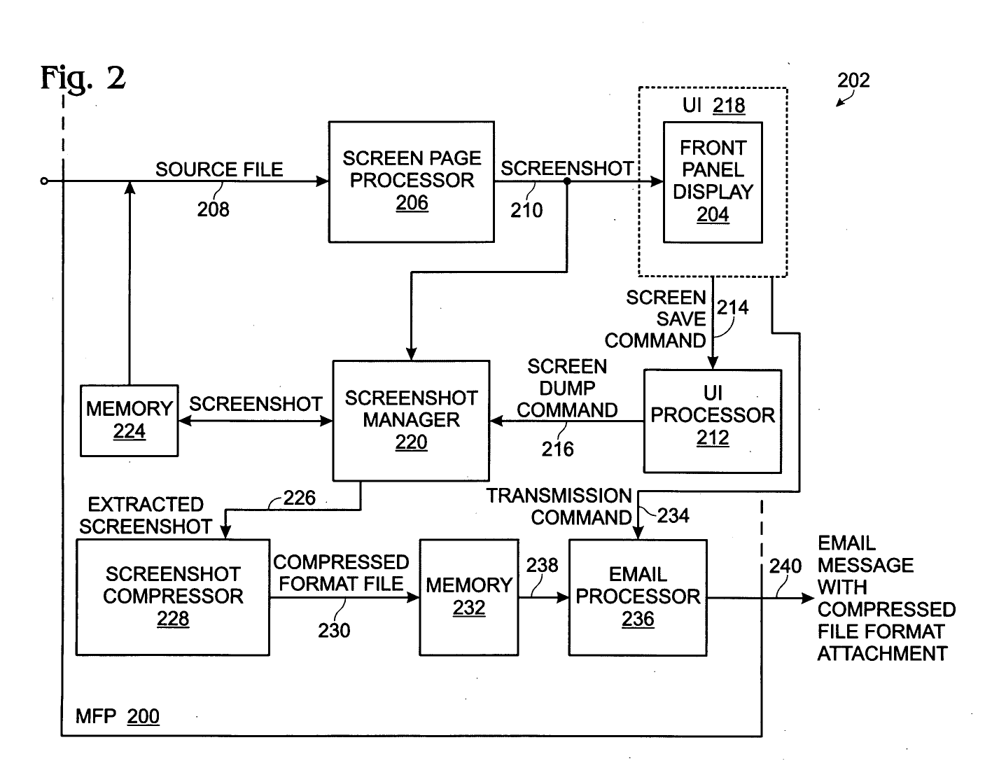

FIG. 2 is a schematic block diagram of an MFP 200 with a system for saving a screenshot displayed on an MFP front panel. The system 202 comprises an MFP front panel display 204 for presenting a screenshot. A screen page processor 206 has an input on line 208 to accept a source file and an output on line 210 to present a screenshot for display on an MFP front panel display. A UI processor 212 has an input on line 214 to accept a print screen command and an output on line 216 to supply a screen save command. For example, the screen save command may be received from a front panel UI 218, such as a keyboard, keypad, or mouse in combination with display 204. Alternately, the screen save command may originate from a network connected client device computer (not shown) or server (not shown).

A screenshot manager 220 has an interface on line 210 to accept the screenshot from the screen page processor for storage in a tangible memory medium 224. The screenshot manager has an output on line 226 to supply the screenshot extracted from the memory 224 in response to receiving the screen save command received on line 216. A screenshot compressor 228 has an input on line 226 to accept the screenshot extracted from memory, and an output on line 230 to supply a compressed screenshot in a compressed file format. Some examples of compressed file formats include Joint Photographic Experts Group (JPG), Tagged Image File Format (TIFF), Bitmap Image File Format (BMPP, and Portable Document Format (PDF). The compressed file format screenshot is stored in memory 232. The screenshot compressor, screen page processor, UI processor, and screenshot manager may be enabled as logical blocks, modules, and circuits, as described above. In one aspect, the screen page processor 206 supplies the screenshot as RGB data on line 210. In another aspect, the screen page processor 206 receives the source file on line 208 in a screen description language, processes the screen description commands within the source file, and generates the screenshot as RGB data from the source file. In another variation, the source file may be HTML text.

In a different aspect, the UI processor 212 receives email attachment commands and supplies transmission commands on line 234. In this aspect, the system 202 further comprises an email processor 236 having an input on line 238 to extract the compressed screenshot from the memory 232, an input on line 234 to accept the transmission commands, and an output (e.g., a network connection) on line 240 to supply the compressed screenshot as an attachment to a transmitted email message.

### Functional Description

The above-described system is superior to conventional methods in that the user is not required to utilize an external device for capturing screenshots of the MFP front panel. This “On demand” printing of the front panel screen not only increases productivity, but decreases the misrepresentation of information. This method allows a simple and effective mechanism by which information displayed on the MFP front panel is automatically recorded onto hardcopy.

The use cases for this system are numerous. The system is useful for Web Service Applications, since the user can easily print search results that are displayed on the front panel without needing the Web Service Application to package the data as separate print job for transmission over the net. The system is useful for Documentation Departments, since the user can easily print all or a subset of the screenshots on the MFP device without needing to create these images using a graphics editing tool.

In one example, the user walks up to the MFP and performs a copy job. The MFP encounters a system error, and displays an error message unknown to the user. In order to send a trouble ticket to the help desk, the MFP extracts the screenshot and sends the screenshot as an email attachment to the help desk. Typically, the MFP has a button or key that permits the user to generate an email of the screen.

In another example, the user walks up to the MFP and selects a Web Service Application, for example, that provides address lookup capabilities. The user searches an address, and the Web Service Application displays the results on the LCD front panel display of the MFP. If the information displayed on the screen is exactly what the user needs, the user presses the button on the MFP to print the screenshot. The MFP prints a hardcopy of the screenshot, and the user has a printed copy of the information for which the user was looking.

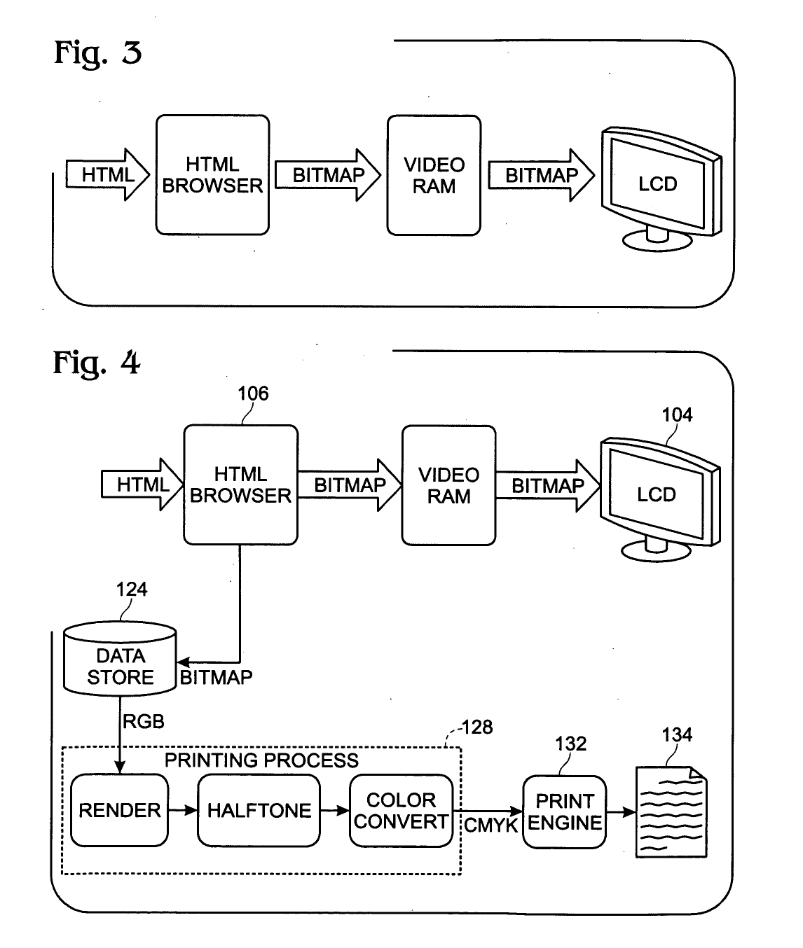

FIG. 3 is a schematic diagram depicting an exemplary process performed by the screen page processor of FIGS. 1 and 2. In order to display screenshots on the front panel display, the MFP first generates a raw bitmap image of the screen page to be displayed. For example, this raw bitmap image may be generated using an internal HTML browser. The internal browser receives pages in HTML format and processes the HTML pages to generate a raw bitmap image representing the picture to be displayed on the front panel display. The image generated by the browser is in the exact resolution of the MFP front panel display, and it is sent directly to the video ram buffer for display.

FIG. 4 is a diagram depicting a variation of the system of FIG. 1. The MFP 200 maintains a copy of this screenshot and prints this screenshot when requested by the user. The screenshot generated by the browser 106 is stored in the MFP's internal storage device 124. When a print screen is requested, the screenshot is extracted from the internal storage device, converted to CMYK format, and submitted to the internal print engine to be printed. The MFP maintains a copy of the latest screenshot displayed on the LCD panel. At the request of the user, the MFP extracts, converts, and prints this screenshot, which results in a hard copy printout of the screenshot currently being displayed on the front panel.

FIG. 6 is a schematic diagram depicting a variation of the system of FIG. 2. The screenshot of the front panel may be attached to an email message for remotely troubleshooting system errors. The screenshot of the front panel screen that is generated by the browser 206 is stored in the MFP's internal storage device 224. When a system error occurs and the MFP displays an error message, the user may request that a screenshot be emailed to the help desk for review. The screenshot of the front panel screen is extracted from the internal storage device 224 and sent as an attachment to an email address selected by the user or an email address setup by the MFP. Typically, the file is compressed before it is attached to the email.

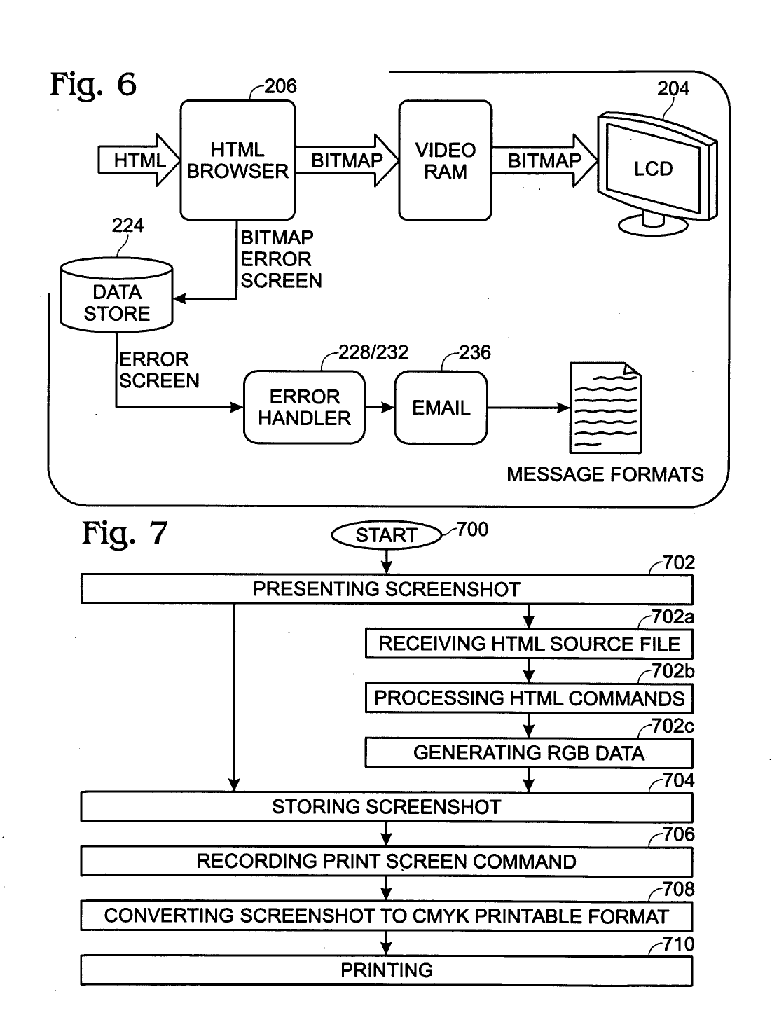

FIG. 7 is a flowchart illustrating a method for printing a screenshot displayed on an MFP front panel. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 700.

Step 702 presents a screenshot on an MFP front panel display. In an MFP processing unit, Step 704 stores the screenshot in a tangible memory medium. Step 706 records a print screen command at a front panel UI. Step 708 extracts the screenshot from memory in the MFP processing unit, and converts the extracted screenshot into a CMYK printable format recognized by a print engine. Step 710 prints a screenshot hardcopy at an MFP print engine.

In independent or combined aspects, Step 702 presents the screenshot as RGB data, and Step 704 stores the screenshot as RGB data. In one variation, Step 708 includes processes for the color conversion and half-toning of the RGB data in the creation of the printable CYMK format.

In another aspect, presenting the screenshot in Step 702 includes substeps. Step 702a receives a source file of the screenshot in a screen description language. Step 702b processes the screen description commands within the source file. Step 702c generates screenshot RBG data from the source file.

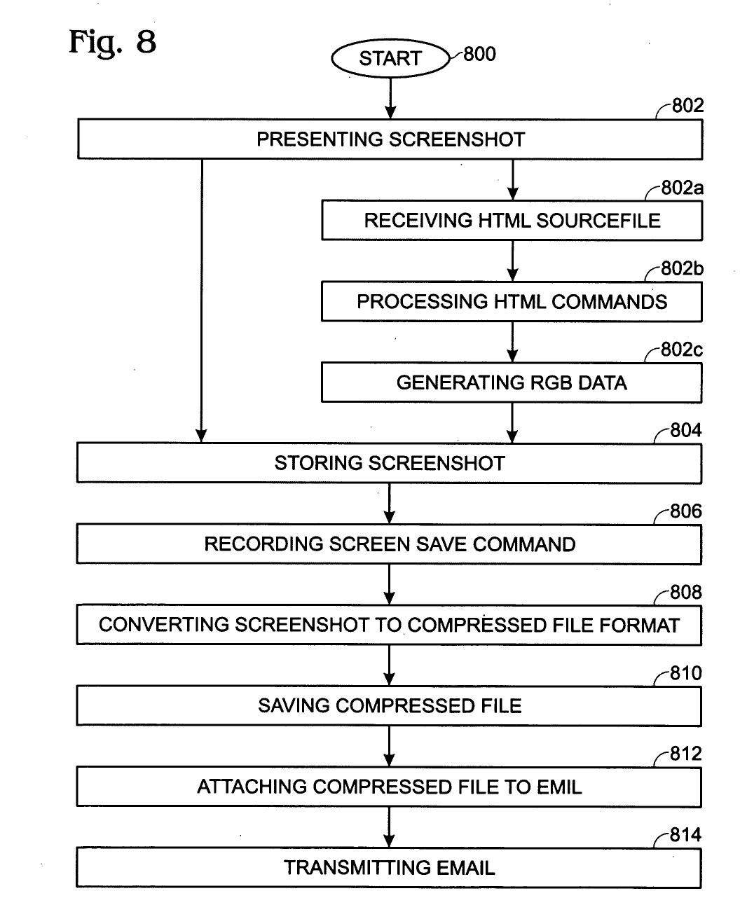

FIG. 8 is a flowchart illustrating a method for saving a screenshot displayed on an MFP front panel. The method begins at Step 800. Step 802 presents a screenshot on an MFP front panel display. In an MFP processing unit, Step 804 stores the screenshot in a tangible memory medium. Step 806 records a save screen command at a front panel UI. Step 808 extracts the screenshot from memory in the MFP processing unit, and converts the extracted screenshot into a compressed file format. Step 810 saves the compressed file in an MFP tangible memory medium.

In one aspect, presenting the screenshot in Step 802 includes presenting a screenshot of RGB data. In another aspect, converting the extracted screenshot into the compressed file format in Step 808 includes compressing the RGB data into an image format such as Joint Photographic Experts Group (JPG), Tagged Image File Format (TIFF), Bitmap Image File Format (BMPP, or Portable Document Format (PDF).

In one aspect, presenting the screenshot in Step 802 includes substeps. Step 802a receives a source file of the screenshot in a screen description language. Step 802b processes the screen description commands within the source file. Step 802c generates screenshot RGB data from the source file.

A different aspect of the method includes additional steps. Step 812 attaches the saved compressed file to an email message. Step 814 transmits the email message.

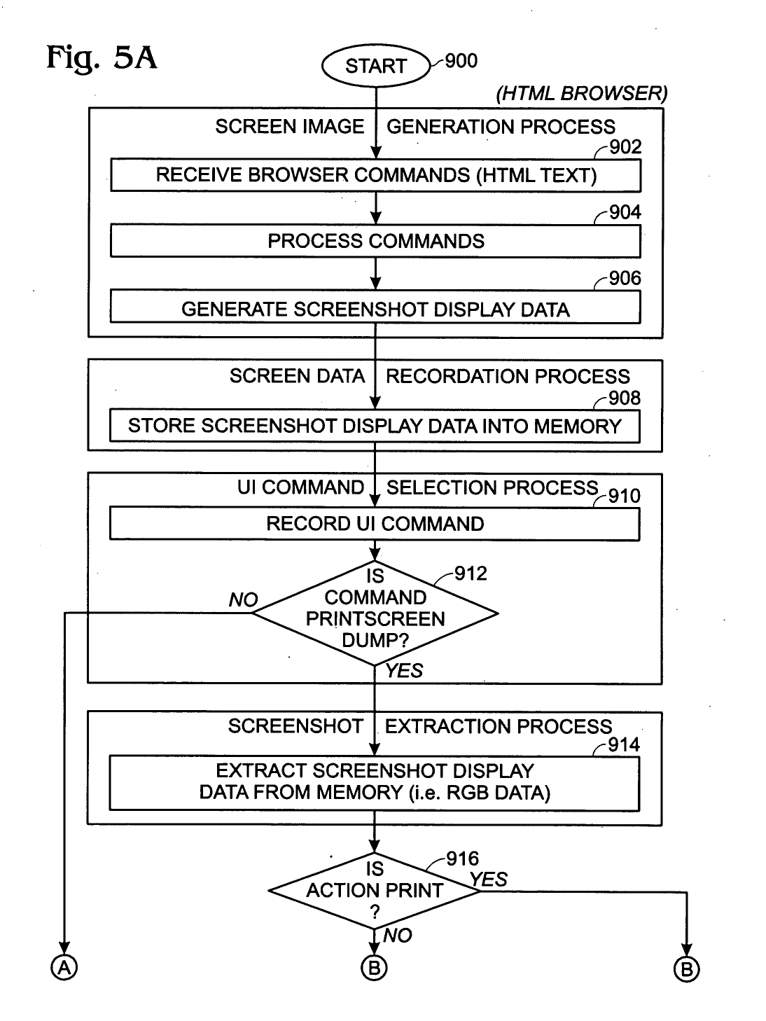

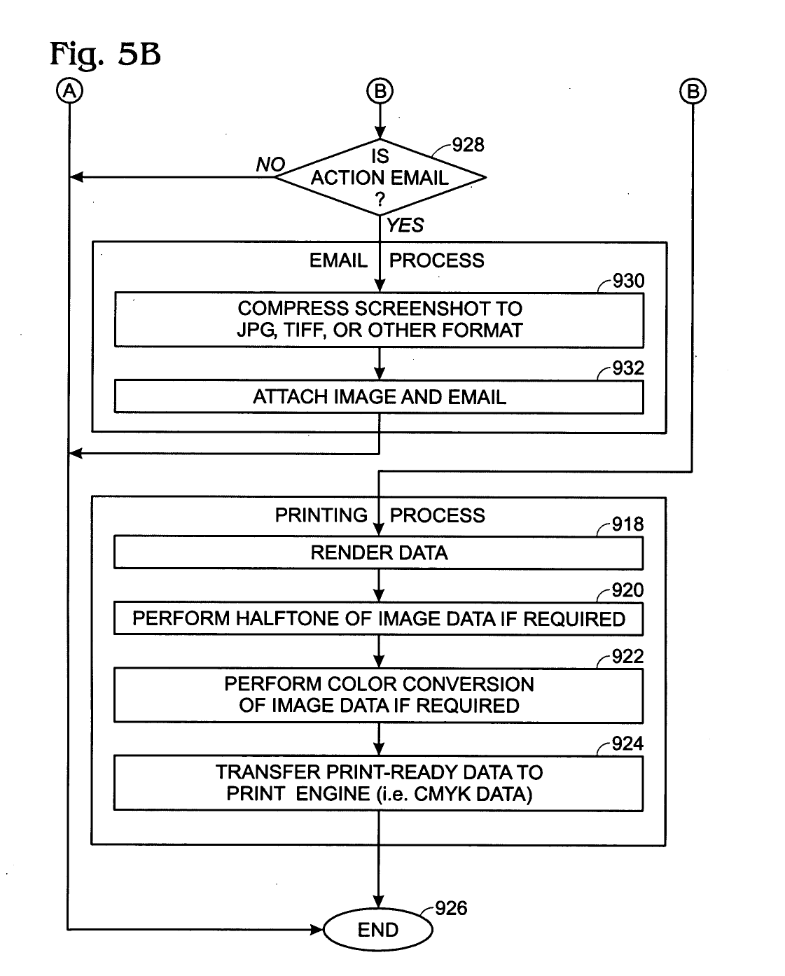

FIGS. 5A and 5B is a flowchart combining aspects of the methods depicted in FIGS. 7 and 8. The method starts at Step 900. Within the context of an HTML browser, Step 902 receives browser commands (a screenshot) as HTML text. Step 904 processes the commands, and Step 906 generates the screenshot RGB data. Step 908 stores the RGB data. In Step 910 a user command is recorded by the UI. In Step 912 a decision is made. If the user command is not a Screen Dump command, the method goes to Step 926 where the process ends. If the user command is a Screen Dump command, the method goes to Step 914, where the screenshot is extracted from memory. If the Screen Dump command specifies printing, Step 916 proceeds to the printing process. In Step 918 the screenshot is rendered. In Step 920 halftoning is performed on the front panel screen image, if required. Step 922 performs color conversion of the front panel screen image, if necessary. Step 924 transfers the printer-ready data to a print engine. If Step 928 determines that the Screen Dump command specifies an email action, Step 940 compresses the screenshot data, and Step 932 attaches the compressed data to an email as a file attachment.

Systems and methods have been presented for saving and printing MFP display screenshots. Some examples of process flows and file formats have been given to illustrate the invention. However, the invention is not limited to merely these examples. Other variations and embodiments of the invention will occur to those skilled in the art.

We claim:

1. A method for printing a screenshot displayed on a multifunctional peripheral (MFP) front panel, the method comprising:
on an MFP front panel display, presenting a screenshot;
in an MFP processing unit, storing the screenshot in a tangible memory medium;
at a front panel user interface (UI), recording a print screen command;
in the MFP processing unit, extracting the screenshot from memory and converting the extracted screenshot into a cyan, magenta, yellow, and key (black) (CMYK) printable format recognized by a print engine; and,
at an MFP print engine, printing a screenshot hardcopy.

2. The method of claim 1 wherein presenting the screenshot includes presenting a screenshot of red, green, and blue (RGB) data.

3. The method of claim 1 wherein presenting the screenshot includes:
receiving a source file of the screenshot in a screen description language;
processing the screen description commands within the source file; and
generating screenshot RBG data from the source file.

4. The method of claim 1 wherein presenting a screenshot includes presenting a screenshot of RGB data; and,
wherein storing the screenshot in a tangible memory medium includes storing the screenshot as RGB data.

5. The method of claim 4 wherein converting the extracted screenshot RGB data into the CYMK printable format includes color conversion and half-toning of the RGB data.

6. A method for saving a screenshot displayed on a multifunctional peripheral (MFP) front panel, the method comprising:
on an MFP front panel display, presenting a screenshot;
in an MFP processing unit, storing the screenshot in a tangible memory medium;
at a front panel user interface (UI), recording a save screen command;
in the MFP processing unit, extracting the screenshot from memory and converting the extracted screenshot into a compressed file format; and,
saving the compressed file in an MFP tangible memory medium.

7. The method of claim 6 wherein presenting the screenshot includes presenting a screenshot of red, green, and blue (RGB) data.

8. The method of claim 7 wherein converting the extracted screenshot into the compressed file format includes compressing the RGB data into an image format selected from a group consisting of Joint Photographic Experts Group (JPG), Tagged Image File Format (TIFF), Bitmap Image File Format (BMPP, and Portable Document Format (PDF).

9. The method of claim 6 further comprising:
attaching the saved compressed file to an email message; and,
transmitting the email message.

10. The method of claim 6 wherein presenting the screenshot includes:
receiving a source file of the screenshot in a screen description language;
processing the screen description commands within the source file; and
generating screenshot RGB data from the source file.

11. A system for printing a screenshot displayed on a multifunctional peripheral (MFP) front panel, the system comprising:
an MFP front panel display for presenting a screenshot;
a screen page processor having an input to accept a source file and an output to present a screenshot for display on an MFP front panel display;
a user interface (UI) processor having an input to accept a print screen command and an output to supply a screen dump command;
a screenshot manager having an interface to accept the screenshot from the screen page processor for storage in a tangible memory medium, and an output to supply the screenshot extracted from the memory in response to receiving the screen dump command;
a screenshot converter having an input to accept the screenshot extracted from memory, and an output to supply the screenshot converted into a file in a cyan, magenta, yellow, and key (black) (CMYK) printable format; and,
an MFP print engine having an input to accept the CMYK printable format file and an output to supply a screenshot hardcopy.

12. The system of claim 11 wherein the screen page processor supplies the screenshot as red, green, and blue (RGB) data.

13. The system of claim 11 wherein the screen page processor receives the source file in a screen description language, processes the screen description commands within the source file, and generates screenshot RBG data from the source file.

14. The system of claim 11 wherein the screen page processor supplies the screenshot as RGB data; and,
wherein the screenshot manager stores the screenshot as RGB data.

15. The method of claim 14 wherein the screenshot converter performs color conversion and half-toning processing of the RGB data.

16. A system for saving a screenshot displayed on a multifunctional peripheral (MFP) front panel, the system comprising:
an MFP front panel display for presenting a screenshot;
a screen page processor having an input to accept a source file and an output to present a screenshot for display on an MFP front panel display;
a user interface (UI) processor having an input to accept a print screen command and an output to supply a screen save command;
a screenshot manager having an interface to accept the screenshot from the screen page processor for storage in a tangible memory medium, and an output to supply the screenshot extracted from the memory in response to receiving the screen save command;
a screenshot converter having an input to accept the screenshot extracted from memory, and an output to supply a compressed screenshot in a compressed file format; and,
a memory for storing the compressed file format screenshot.

17. The system of claim 16 wherein the screen page processor supplies the screenshot as red, green, and blue (RGB) data.

18. The system of claim 17 wherein the screenshot converter supplies the extracted screenshot as a compressed file in an image format selected from a group consisting of Joint Photographic Experts Group (JPG), Tagged Image File Format (TIFF), Bitmap Image File Format (BMPP, and Portable Document Format (PDF).

19. The system of claim 16 wherein the UI processor receives email attachment commands and supplies transmission commands;
the system further comprising:
an email processor having an input to extract the compressed screenshot from the memory, and input to accept the transmission commands, and an output to supply the compressed screenshot as an attachment to a transmitted email message.

20. The system of claim 16 wherein the screen page processor receives the source file in a screen description language, processes the screen description commands within the source file, and generates the screenshot as RGB data from the source file.
